(19) United States
(12) Patent Application Publication
(10) Pub. No.: US 2014/0313873 A1
(43) Pub. Date: Oct. 23, 2014

(54) DETECTING APPARATUS FOR HARD DISK DRIVE

(71) Applicant: HON HAI PRECISION INDUSTRY CO., LTD., New Taipei (TW)

(72) Inventors: KANG WU, Shenzhen (CN); BO TIAN, Shenzhen (CN)

(73) Assignee: HON HAI PRECISION INDUSTRY CO., LTD., New Taipei (TW)

(21) Appl. No.: 14/254,972

(22) Filed: Apr. 17, 2014

(30) Foreign Application Priority Data
Apr. 17, 2013 (CN) 201310133514X

(51) Int. Cl. G11B 27/36

(52) U.S. Cl. CPC G11B 27/36
USPC 369/53.42

(57) ABSTRACT

A detecting circuit for a number of hard disk drives (HDDs) includes a backplane, a control circuit, a converting circuit, and an integrated baseboard management controller (IBMC) chip. The backplane is connected to the HDDs and outputs state signals of the HDDs corresponding to operation information of the HDDs to the control circuit. The control circuit outputs parallel signals corresponding to the state signals to the converting circuit. The converting circuit converts the parallel signals into serial signals and outputs the serial signals to the IBMC chip. Operation information of the HDDs is obtained through the IBMC chip remotely.

### FIELD

The present disclosure relates to a detecting apparatus for hard disk drives (HDDs).

### BACKGROUND

One or more hard disk drives (HDDs) are employed to extend the storage capacity of a server.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a block diagram of an example embodiment of a detecting apparatus according to the present disclosure, wherein the detecting apparatus comprises a control circuit, an indicator circuit, a first connector, a first converting circuit, a second connector, and a second converting circuit.

FIG. 2 is a circuit diagram of the control circuit, the indicator circuit, and the first connector of FIG. 1.

FIG. 3 is a circuit diagram of the first converting circuit of FIG. 1.

FIG. 4 is a circuit diagram of the second converting circuit and the second connector of FIG. 1.

### DETAILED DESCRIPTION

The disclosure is illustrated by way of example and not by way of limitation in the figures of the accompanying drawings in which like reference numbers indicate similar elements. It should be noted that references to “an” or “one” embodiment in this disclosure are not necessarily to the same embodiment, and such references mean “at least one.”

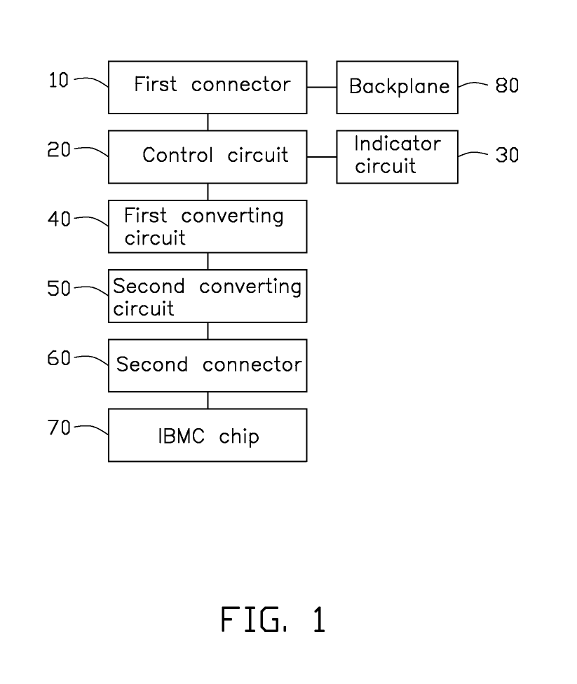

FIG. 1 illustrates an example embodiment of a detecting apparatus according to the present disclosure. The detecting apparatus comprises a backplane 80, a first connector 10 coupled to the backplane 80, an indicator circuit 30, a control circuit 20 coupled to the first connector 10 and the indicator circuit 30, a first converting circuit 40, a second converting circuit 50, a second connector 60, and an integrated baseboard management controller (IBCM) chip 70.

In an embodiment, the backplane 80 can be coupled to a plurality of hard disk drives (HDDs), and can output state signals of the plurality of HDDs. In one embodiment, there can be eight HDDs coupled to the backplane 80.

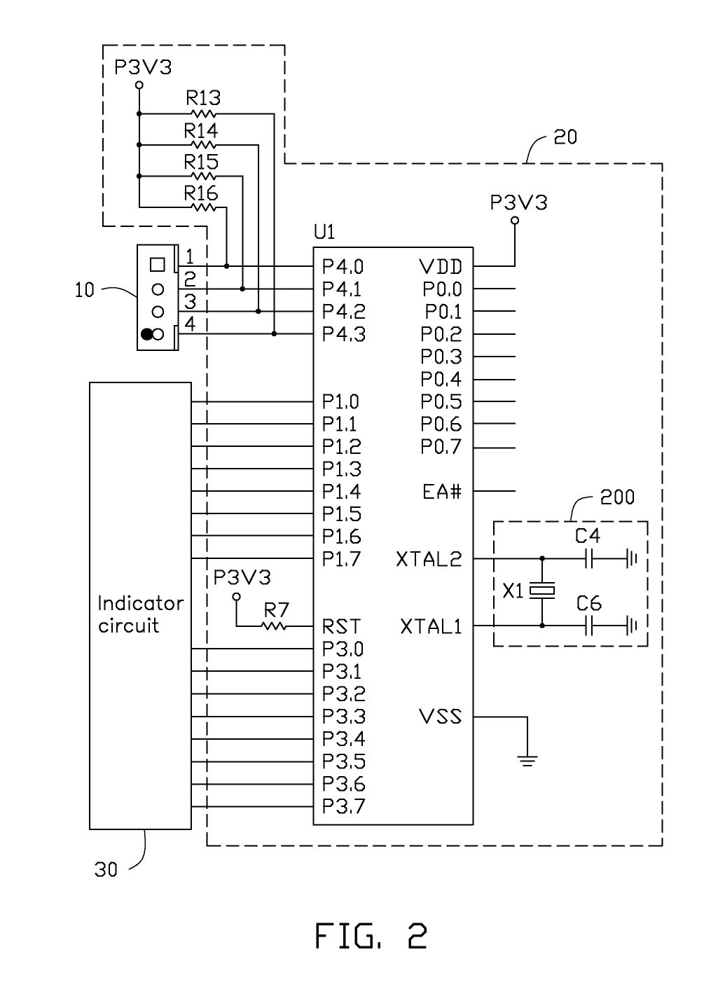

FIG. 2 illustrates circuit diagrams of the first connector 10, the indicator circuit 30, and the control circuit 20.

The first connector 10 is electrically connected to the backplane 80 to receive the state signals from the backplane 80. The first connector 10 can comprise first through fourth pins 1-4. The first through fourth pins 1-4 of the first connector 10 can be coupled to the backplane 80. In an embodiment, the state signal indicates operation information of the corresponding HDD, such as a work state or a malfunctional state.

The control circuit 20 can be coupled to the first connector 10 to receive the state signals from the first connector 10. The control circuit 20 is further coupled to the indicator circuit 30, and outputs indicating signals to the indicator circuit 30 according to the state signals. The indicator circuit 30 can comprise a plurality of light-emitting diodes (not shown), from which the operation information of the HDDs can be obtained by a user.

The control circuit 20 can comprise a control chip U1, resistors R7 and R13-R16, and a crystal circuit 200. Pins P4.0-P4.3 of the control chip U1 are coupled to the first through fourth pins 1-4 of the first connector 10, respectively. Pins 4.0-4.3 of the control chip U1 can further be coupled to a power terminal P3V3 through the resistors R13-R16, respectively. The control chip U1 can obtain the operation information of the HDDs according to the state signals.

Pins P1.0-P1.7 and P3.0-P3.7 of the control chip U1 are coupled to the indicator circuit 30. The pins P1.0-P1.7 of the control chip U1 can output malfunctional signals corresponding to the first through eighth HDDs, respectively. For example, if the first HDD malfunctions, the pin 1.0 of the control chip U1 outputs a malfunction signal to the indicator circuit 30. Pins P3.0-P3.7 of the control chip U1 can output work signals corresponding to the first through eighth HDDs, respectively. For instance, if the second HDD operates normally, the pin P3.1 of the control chip U1 outputs a work signal to the indicator circuit 30.

In an embodiment, the pins P0.0-P0.7 of the control chip U1 can output a parallel signal with respect to the state signals.

A reset pin RST of the control chip U1 can be coupled to the power terminal P3V3 through the resistor R7.

The crystal oscillator circuit 200 can comprise capacitors C4 and C6, and a crystal oscillator X1. Crystal pins XTAL1 and XTAL2 of the control chip U1 are electrically connected to ground through the capacitors C4 and C6, respectively. The crystal oscillator X1 is electrically connected between the crystal pins XTAL1 and XTAL2. A ground pin VSS of the control chip U1 is electrically connected to ground. A power pin VDD of the control chip U1 is electrically connected to the power terminal P3V3.

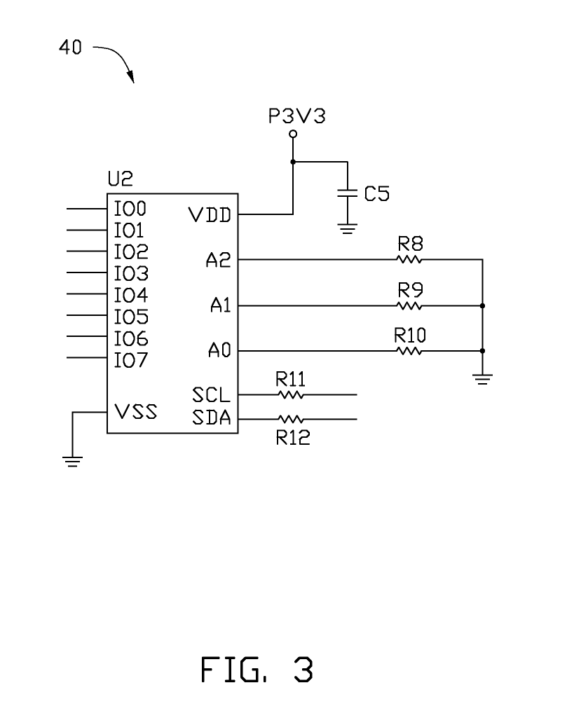

FIG. 3 illustrates circuit diagram of the first converting circuit 40. The first converting circuit 40 converts the parallel signal into a serial signal. The first converting circuit 40 can comprise a converting chip U2, resistors R8-R12, and a capacitor C5. Pins 100-107 of the converting chip U2 can be coupled to the pins P0.0-P0.7 of the control chip U1, respectively, to receive the parallel signals from the control chip U1.

A ground pin VSS of the converting chip U2 is electrically connected to ground. A power pin VDD of the converting chip U2 is coupled to the power terminal P3V3, and further electrically connected to ground through the capacitor C5. Address pins A0-A2 can be electrically connected to ground through the resistors R10, R9, and R8, respectively, to define an address of the converting chip U2, such as an address with 40H. A clock signal pin SCL and a data pin SDA of the converting chip U2 are coupled to the resistors R11 and R12, respectively, to output the serial signal.

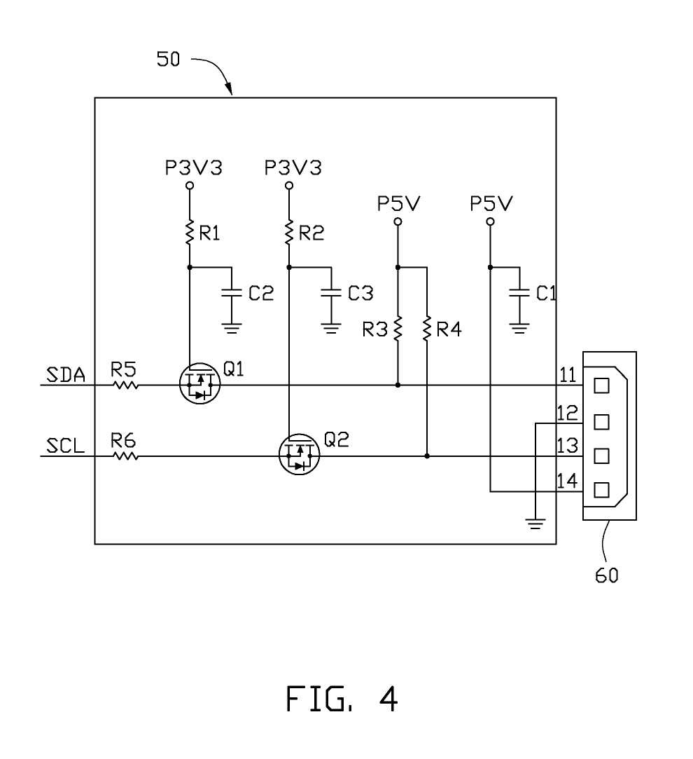

FIG. 4 illustrates circuit diagram of the second converting circuit 50. The second converting circuit 50 can convert the serial signal into a control signal complying with the IBCM chip 70. The second converting circuit 50 can comprise two metal-oxide semiconductor field-effect transistors (MOSFET) Q1 and Q2, six resistors R1-R6, and three capacitors C1-C3.

A source of the MOSFET Q1 can be coupled to the data pin SDA of the converting chip U2 through the resistor R5. A gate of the MOSFET Q1 can be coupled to the power terminal P3V3 through the resistor R1, and further be electrically connected to ground through the capacitor C2. A drain of the MOSFET Q1 can be coupled to a first pin 11 of the second connector 60. A second pin 12 of the second connector 60 can be electrically connected to ground. A source of the MOSFET Q2 can be coupled to the clock signal pin SCL through the resistor R6. A gate of the MOSFET Q2 can be coupled to the power terminal P3V3, and further be electrically connected to ground through the capacitor C3. A drain of the MOSFET Q2 can be coupled to a third pin 13 of the second connector 60. The first and third pins 11 and 13 of the second connector 60 can be coupled to a power terminal P5V through the resistors R3 and R4, respectively. A fourth pin 14 of the second connector 60 can be coupled to the power terminal PSV, and be further electrically connected to ground through the capacitor C1.

In use, the control circuit 20 can obtain the state signals from the backplane 80 through the first connector 10, thereby obtaining the operation information of the HDDs. When at least one of the HDDs operates normally, the control chip U1 outputs the work signals of the operating HDDs to the indicator circuit 30 through one or more pins P3.0-P3.7. The indicator circuit 30 can emit light of the corresponding LEDs upon receiving the work signals. When at least one of the HDDs malfunctions, the control chip U1 outputs the malfunction signals of the corresponding HDDs to the indicator circuit 30 through one or more pins P1.0-P1.7. The indicator circuit 30 can turn off the lights of the LEDs upon receiving the malfunction signals. The control chip U1 further outputs the parallel signal to the first converting circuit 40. The first converting circuit 40 can further convert the parallel signal into the serial signal, and output the serial signal to the second converting circuit 50. The second converting circuit 50 can convert the serial signal into the control signal, and output the control signal to the IBMC chip 70. Accordingly, if the HDDs malfunction for certain operation information; the IBMC chip 70 can send out alarm and also record the operation information. Hence, a user can obtain the operation information of the HDDs from the IBMC chip 70.

While the disclosure has been described by way of example and in terms of a preferred embodiment, it is to be understood that the disclosure is not limited thereto. On the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A detecting circuit for a plurality of hard disk drives (HDDs), comprising:
a backplane connected to the HDDs, and the backplane configured to output state signals of the HDDs corresponding to operation information of the HDDs;
a control circuit connected to the backplane, to receive the state signals, and the control circuit configured to output a parallel signal with respect to the state signals; and
a first converting circuit connected to the control circuit, and the first converting circuit configured to convert the parallel signal to a serial signal, and the first converting circuit configured to output the serial signal to an integrated baseboard management controller (BMC) chip.

2. The detecting circuit of claim 1, further comprising:
an indicator circuit providing indication of the operation information of the HDDs.

3. The detecting circuit of claim 2, further comprising:
a second converting circuit configured to convert the serial signal to a control signal complying with the IBMC chip.

4. The detecting circuit of claim 2, further comprising:
a first connector connected between the backplane and the control circuit.

5. The detecting circuit of claim 3, further comprising:
a first connector connected between the backplane and the control circuit.

6. The detecting circuit of claim 5, further comprising:
a second connector connected between the second converting circuit and the IBMC chip.

7. The detecting circuit of claim 4, wherein the control circuit comprises a control chip, first to fourth pins of the control chip are coupled to first to fourth pins of the first connector; fifth to twelfth pins of the control chip are coupled to the indicator circuit to indicate the HDDs being malfunction; thirteenth to twentieth pins of the control chip are coupled to the indicator circuit to indicate the HDDs being operation; twenty-first to twenty-eighth pins of the control chip output the parallel signal.

8. The detecting circuit of claim 7, wherein the first converting circuit comprises a converting chip, first to eighth pins of the converting chip are coupled to the twenty-first to twenty-eighth pins of the control chip, respectively, ninth and tenth pins of the converting chip output the serial signal.

9. The detecting circuit of claim 6, wherein the control circuit comprises a control chip, first to fourth pins of the control chip are coupled to first to fourth pins of the first connector; fifth to twelfth pins of the control chip are coupled to the indicator circuit to indicate the HDDs being malfunction; thirteenth to twentieth pins of the control chip are coupled to the indicator circuit to indicate the HDDs being operation; twenty-first to twenty-eighth pins of the control chip output the parallel signal.

10. The detecting circuit of claim 9, wherein the first converting circuit comprises a converting chip, first to eighth pins of the converting chip are coupled to the twenty-first to twenty-eighth pins of the control chip, respectively, ninth and tenth pins of the converting chip output the serial signal.

11. The detecting circuit of claim 10, wherein the second converting circuit comprises a first metal oxide semiconductor field effect transistors (MOSFET) and a second MOSFET; a source of the first MOSFET is coupled to the ninth pin of the converting chip, a gate of the first MOSFET is coupled to a first power terminal through a first resistor; a drain of the first MOSFET is coupled to a first pin of the second connector; a source of the second MOSFET is coupled to the tenth pin of the converting chip, a gate of the second MOSFET is coupled to the first power terminal through a second resistor; a drain of the first MOSFET is coupled to a second pin of the second connector.

12. The detecting circuit of claim 11, wherein the gate of the first MOSFET is connected to a ground through a first capacitor; and the gage of the second MOSFET is connected to a ground through a second capacitor.

13. The detecting circuit of claim 12, wherein the first and second pins of the second connector are connected to a second power terminal through third and fourth resistors, respectively; a third pin of the second connector is connected to a ground, and a fourth pin of the second connector is coupled to the second power terminal.
